(19) United States
(12) Patent Application Publication
(10) Pub. No.: US 2005/0149740 A1
(43) Pub. Date: Jul. 7, 2005

(54) Method and apparatus for device authentication

(76) Inventors: Michael D. Kotzin, Buffalo Grove, IL (US); John D. Bruner, South Barrington, IL (US); Steve R. Bunch, Harvard, IL (US)

Correspondence Address: MARSHALL, GERSTEIN & BORUN (MOTOROLA), 233 SOUTH WACKER DRIVE, SUITE 6300, CHICAGO, IL, 60606-6402, US

(21) Appl. No.: 10/749,820

(22) Filed: Dec. 31, 2003

(51) Int. Cl. H04K 1/00

(52) U.S. Cl. 713/185

(57) ABSTRACT

A method of authenticating an electronic device (100) utilizes device specific identifying data stored within the electronic device (100), and for example, information stored in or computed by a subscriber identity module (SIM) card (212) of the electronic device (100). A plurality of challenge and response pairs based upon the device specific identifying data are generated and stored in a database (110). When the electronic device (100) is to be authenticated, a challenge and response pair is selected and the challenge is communicated to the electronic device (100). The electronic device (100) responds with a response, the received response is compared to a response portion of the challenge response pair. A match confirms authentication.

### TECHNICAL FIELD

This patent relates to authentication of a wireless communication device user and more particularly to a method and apparatus allowing subscriber service providers to authenticate users via secure stored device data.

### BACKGROUND

Wireless communication device subscriber service providers, which may include providers of applications, content, services and the like to wireless communication device users, i.e., subscribers, require the ability to reliably authenticate specific subscribers. The traditional methods of authenticating a subscriber are controlled by the network operator providing wireless communication services to the user. These methods may utilize methods of accessing stored secure data within the wireless communication device and algorithms for authenticating the data to verify user identity. For example, the network operator may authenticate a user by querying the subscriber identity module (SIM) card of the wireless communication device in connection with application of an authentication algorithm. This technique is not generally available to the public for several reasons. For example, for security considerations network operators prefer not to allow third parties access to the authentication algorithms.

While the SIM card method and other methods of querying secure data within the wireless communication device via an authentication algorithm reliably authenticate specific users, because these methods are not generally publicly available other methods have been proposed. These other methods include providing additional secure hardware, such as an additional “Smart Card”, within the wireless communication device. The additional hardware, however, increases the cost and complexity of the wireless communication device, which is undesirable. Other techniques, such as digital rights management (DRM) techniques, are often easily circumvented because of the lack of a secure method to validate the subscriber. The increase in the number of software applications, and the methods for delivering these software applications to subscribers, e.g., wireless data download, highlight the importance of authenticating the subscriber before the application is delivered.

### BRIEF DESCRIPTION OF THE DRAWINGS

FIG. 1 is a block diagram of a wireless communication system in accordance with a described embodiment.

FIG. 2 is a block diagram illustrating a wireless communication device operable within the wireless communication system depicted in FIG. 1.

FIG. 3 is a flow chart illustrating a method of subscriber authentication in accordance with a described embodiment.

FIG. 4 is a flow chart illustrating a method of subscriber authentication in accordance with an alternate described embodiment.

### DETAILED DESCRIPTION OF THE EMBODIMENTS

A method of authenticating an electronic device utilizes device specific identifying data stored within the device, and for example, information stored in a subscribed identity module (SIM) card of the device. A plurality of challenge and response pairs based upon the device specific identifying data are generated and stored in a database. When the electronic device is to be authenticated, a challenge and response pair is selected and the challenge is communicated to the electronic device. The electronic device responds with a response, the received response is compared to a response portion of the challenge response pair. A match confirms authentication. In order to guard against future spoofing by entities monitoring non-secure authentication communications, the challenge-response pair may be deleted after one usage.

As another aspect of the invention, authentication services may be provided to third party service providers/vendors. The authentication service or agent may collect from users of electronic devices a plurality of challenge response pairs. The authentication agent may then sell or distribute the challenge and response pairs in a secure manner to service providers/vendors to use to authenticate users.

Although the following text sets forth a detailed description of numerous different embodiments of the invention, it should be understood that the legal scope of the invention is defined by the words of the claims set forth at the end of this patent. The detailed description is to be construed as exemplary only and does not describe every possible embodiment of the invention because describing every possible embodiment would be impractical, if not impossible. Numerous alternative embodiments could be implemented, using either current technology or technology developed after the filing date of this patent, which would still fall within the scope of the claims defining the invention.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. § 112, sixth paragraph.

It is further understood that the use of relational terms, if any, such as first and second, top and bottom, and the like are used solely to distinguish one from another entity or action without necessarily requiring or implying any actual such relationship or order between such entities or actions.

Much of the inventive functionality and many of the inventive principles are best implemented with or in software programs or instructions and integrated circuits (ICs) such as application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts in accordance to the present invention, further discussion of such software and ICs, if any, will be limited to the essentials with respect to the principles and concepts of the preferred embodiments.

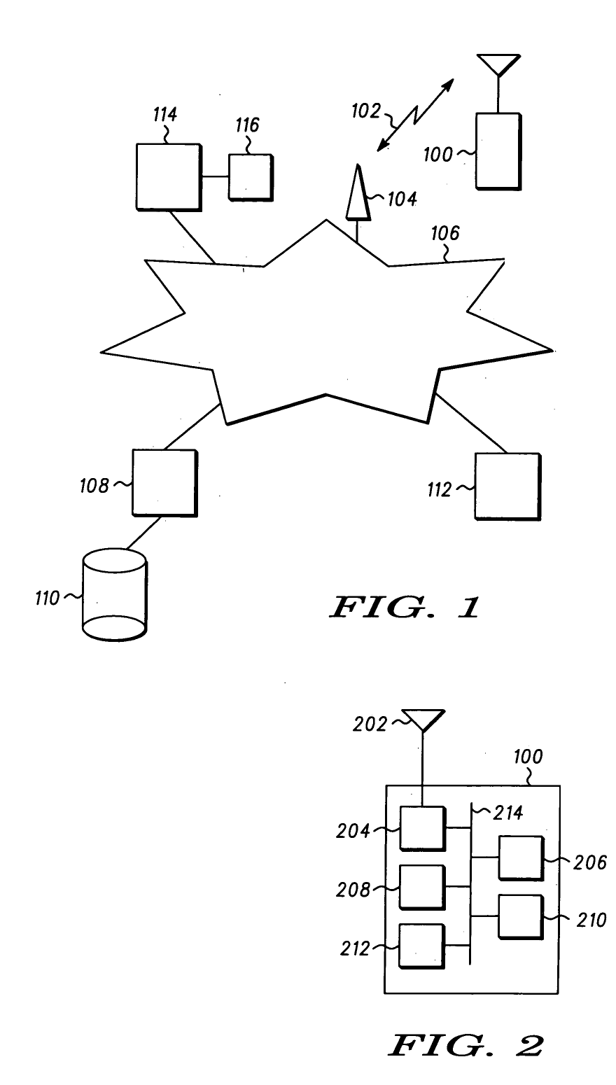

Referring to FIG. 1, an electronic device 100 communicates via an air interface 102 with a communication infrastructure 104 of a wireless communication system. The communication infrastructure 104 may be communicatively coupled to a communication network 106 via a gateway or other suitable interface (not depicted). The communication network 106 may be any suitable network for communicating data, such as voice, text, graphics, multimedia and the like, and may be a local area network, a wide area network, the Internet, a circuit switched network and the like. The air interface may be specified in accordance with any suitable wireless communication protocol. These protocols may include the Global System for Mobile Communications (GSM), the Enhanced Data-rate for GSM Evolution (EDGE), the General Packet Radio Service (GPRS), the Universal-Mobile Telecommunications System (UMTS), Frequency Division Multiple Access (FDMA), the IS-55 Time Division Multiple Access (TDMA) digital cellular, the IS-136 TDMA digital cellular, the IS-95 Code Division Multiple Access (CDMA) digital cellular, demand assignment schemes (DA/TDMA, DA/CDMA, DA/FDMA), the Wideband Code Division Multiple Access (WCDMA), CDMA 2000, IMT-2000, the Personal Communications System (PCS), 3GPP, as well as variations and evolutions of these protocols. Moreover, the electronic device 100 and the communication infrastructure 104 may be adapted to operate in accordance with one or more of these protocols.

Further coupled to the communication network 106 is an authentication agent 108 including a coupled database 110, a service provider agent 112 and a subscriber identity module (SIM) card vendor agent 114. The SIM card vendor agent 114 may operably couple SIM cards 116 to the network 106.

The elements of the system in FIG. 1 are known and available. The electronic device 100, in this instance, a wireless communication device, is available from manufacturers such as Motorola. The communication infrastructure 104 similarly is available from companies such as Motorola. The authentication agent 108, service provider 112 and SIM card vendor could be any standard off-the-shelf computer system designated for the particular purpose, from companies such as Sun, Hewlett Packard, or Dell and run using Windows, LINUX, UNIX or other suitable operating systems.

Referring now to FIG. 2, the electronic device 100 may include an antenna 202, a transceiver 204, a processor 206, a memory 208, a SIM card 210 and a user interface 212 coupled via a communication bus 214. The antenna 202 and the transceiver 204 are adapted to wirelessly communicate data with and between the communication infrastructure 104 via the air interface 102 in accordance with one or more communication protocols. The memory 208 may contain one or more operating programs for directing the processor for controlling the transceiver 204 and for accepting from and presenting data to the user of the electronic device 100 via the user interface 212. Device specific identifying data and one or more authentication algorithms, and other operating data as is well known in the art, may be retained within the SIM card and be accessible by the processor via the communication bus 214. Of course, the device specific identifying data and algorithms may be otherwise stored within the electronic device 100, and for example such information could be stored in the memory 208.

In order to allow a third party, such as the service provider agent 112 to authenticate the electronic device 100, i.e., the subscriber, before rendering a service, a process is provided to allow the third party to exploit the device specific identifying data and/or algorithms retained within the memory device. In one example, the third party may be permitted to exploit the SIM card 212 of the electronic device 100 in manner that does not require prior knowledge of the algorithm that is contained therein. A SIM card contains both unique secret identification information as well as a microprocessor subsystem which has proprietary authentication algorithms. The SIM card is a trusted computing environment which is not accessible from the outside. Therefore, the secret information, the algorithms, and all the intermediary computations it does for authentication are unobtainable by the user or a third party service provider.

Referring again to FIG. 1, the authentication agent 108 and associated database 110 may be arranged to provide user authentication via exploitation of stored device specific identifying data and/or authentication algorithms, and particularly SIM data and algorithms, within the electronic device. While the authentication agent 108 is shown as a separate entity arranged to provide an authentication service, the functionality of the authentication agent 108 may be incorporated into or integrated with other functionality, such as service provider 112. The authentication agent 108 is arranged to challenge the electronic device 100, and particularly the SIM card 212, in order to obtain corresponding responses from the electronic device 100. These challenge and response pairs are then stored within the database 110 in association with the electronic device 100. Virtually any number of challenge and response pairs may be generated, and depending on the frequency with which the electronic device 100 will require authentication service, the number of challenge and response pairs may be as low several or as high as several thousand. Advantageously, the challenge and response pairs are not stored within the memory of the electronic device 100, therefore the memory requirements of the electronic device 100 are not affected. Instead, the challenge and response pairs are stored within the database 110, which can easily be configured and expanded to accommodate literally thousands of users and associated thousands or even millions of challenge and response pairs. This set of pairs can be thought of as, and used much as, a One-Time Pad, which is well known to practitioners in the art. In use, the challenge and response pairs may be sent over the air interface 102 and communicated via the network 106, and thus may be susceptible to interception. In the event that securing the entire communication path between the device 100, database 110, service provider 112, and SIM card 116 to protect challenge-response pairs from compromise is impracticable, obtaining and storing a sufficiently large number of pairs may permit single usage of a challenge/response pair. Alternatively, the large number of challenge/response pairs may make reliable interception impracticable should reuse be elected.

The way the “conventional” authentication process works is that authenticator (person who wants to authenticate somebody) makes up a random number. This random number (“the challenge”) is sent to the authenticatee (the person who needs to be authenticated) via an authentication protocol. Upon receiving the random challenge, the authenticate applies it to the SIM card. The SIM card microprocessor, using the onboard secret identification information and proprietary algorithms, processes the random challenge and arrives at a challenge response. This challenge response can only be obtained by knowing the secret identification information and the secret authentication algorithms. This challenge response is output from the SIM card where is sent back to the authenticator via the authentication protocol. The authenticator (typically the network operator), knowing both the secret identification information and the authentication algorithms on the SIM, can independently determine what the correct challenge response should be. If the challenge response returned from the authenticatee is the same what the authenticator independently determines, the authentication process is deemed successful.

In the case of the described embodiments, it is advantageously possible to authenticate someone without knowing the secret identification information nor the secret authentication algorithms on their SIM. This is accomplished by challenging the specific SIM device (either locally or remotely) with a large number of random challenges. The challenge responses the SIM puts out are captured with the corresponding random challenge used to obtain the data base of challenge/response pairs.

To obtain the challenge and response pairs, the authentication agent 108 requires either direct or indirect access to the electronic device 100. Direct access may be made by physically connecting to and interrogating the SIM card 212. Alternatively, a secure communication between the electronic device 100 and the authentication agent 108 may be established, wirelessly or otherwise, to permit the interrogation in a manner that preserves security of the system. Such secure communication links and transmission methods are within the skill of one having ordinary skill in the art and are not discussed here.

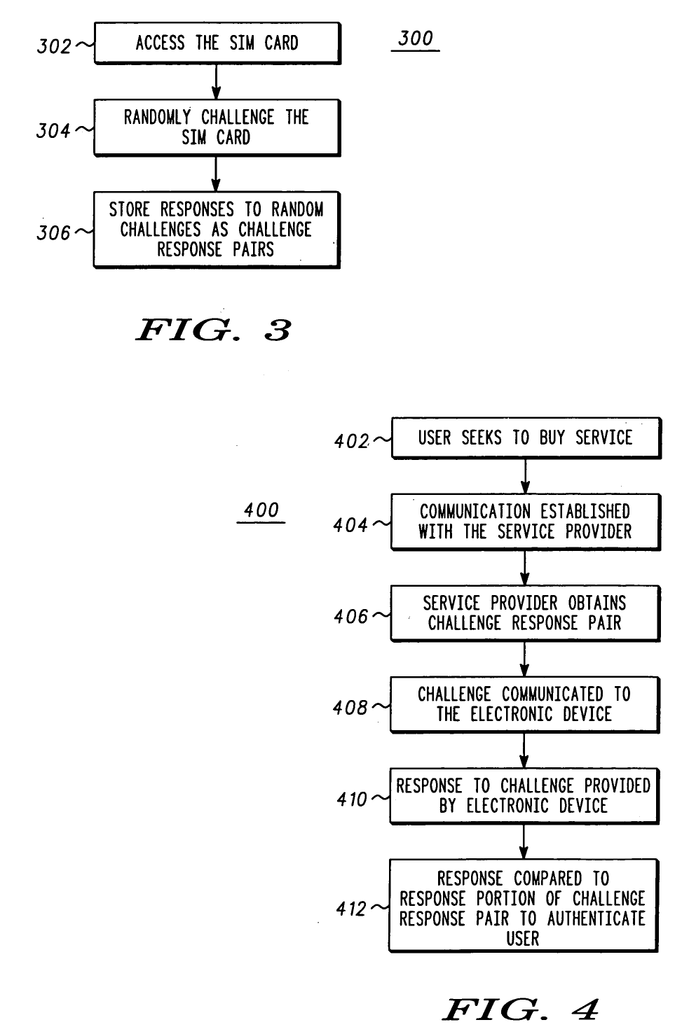

Turning now to FIG. 3, a process 300 for obtaining the challenge and response pairs is discussed. At step 302, the authentication agent 108 obtains access to the device specific identifying information of the electronic device 100, and particularly to the SIM card 212. This access may be physical, in that the electronic device 100 or at least the SIM card 212 is physically present and may be directly coupled to an authentication agent 108 for interrogation. Alternatively, the access may be indirect, in that the electronic device 100 is arranged to communicate either by a wire or wireless interface with the authentication agent 108.

At step 304, the authentication agent 108 interrogates the electronic device 100. That is, the authentication agent 108 makes a number of random challenges. A response to a random challenge is saved along with the random challenge as a challenge response pair, step 306. As noted, enough challenge response pairs may be obtained to ensure that challenge and response pairs need not be reused once sent over the air to authenticate the electronic device 100.

FIG. 4 illustrates use of the authentication methodology. At step 402 a user of an electronic device seeks to acquire, i.e., buy, lease or otherwise obtain, an application, service, content or the like from a service provider/vendor, such as service provider 112. Communication is established between the electronic device and the service provider, for example as shown in FIG. 1 via the air interface 102, communication infrastructure 104 and the communication network 106, step 404. The service provider 112 may obtain from the authentication agent 108 a challenge response pair for the particular electronic device to be authenticated in order to authenticate that electronic device, step 406. The service provider 112 communicates the challenge to the electronic device, step 408, and the electronic device provides a response to the challenge, step 410. The service provider 112 then compares the response to the predetermined response, step 412, to authenticate the user. The communication of the challenge response pair from the authentication agent 108 to the service provider 112 may be by any secure transmission methodology via the network 106 or may be physical delivery of the data. Alternatively, as discussed, the service provider 112 may maintain its own data based of challenge and response pairs for particular users of its services.

Referring again to FIG. 1, a SIM card vendor 114 having access to a store of SIM cards 116 may generate challenge response pairs for SIM cards. The SIM cards may be sold to users of electronic devices, and the challenge response pairs may be brokered by the SIM card vendor 114 or otherwise made available to third party service providers/vendors for use to authenticate users of the vended SIM card 116.

This disclosure is intended to explain how to fashion and use various embodiments in accordance with the invention rather than to limit the true, intended, and fair scope and spirit thereof. The foregoing description is not intended to be exhaustive or to limit the invention to the precise form disclosed. Modifications or variations are possible in light of the above teachings. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

1. A method of authenticating an electronic device, the electronic device having device specific identifying data stored therein, the method comprising:
obtaining a previously determined challenge response pair associated with the electronic device, the challenge response pair being unique and based upon the device specific identifying data of the electronic device;
communicating a challenge portion of the challenge response pair to the electronic device;
receiving from the electronic device a response to the challenge portion the response being based upon the device specific identifying information; and
comparing the response to a response portion of the challenge response pair to authenticate the user.

2. The method of claim 1, wherein the step of obtaining a challenge response pair comprises obtaining from a database store of challenge response pairs the challenge response pair.

3. The method of claim 1, wherein the step of obtaining a challenge response pair comprises generating and storing a plurality of challenge response pairs.

4. The method of claim 1, wherein the step of obtaining a challenge response pair comprises obtaining a challenge response pair from a challenge response pair broker.

5. The method of claim 1, wherein the device specific identifying data comprises data stored on a subscriber identity module (SIM) card associated with the electronic device, or computed by the SIM card upon demand.

6. The method of claim 1, comprising the step of discarding the challenge response pair after use.

7. The method of claim 1, wherein the step of obtaining a challenge response pair comprises obtaining via a secure communication interface the challenge response pair.

8. A system for device authentication comprising:
an agent for interrogating an electronic device to obtain at least one challenge response pair, the challenge response pair being based upon device specific identifying data retained within the electronic device;
a memory for storing the challenge response pair; and
an agent for providing the challenge response pair from the memory to a user of the challenge response pair for authenticating an electronic device.

9. The system of claim 8, wherein the device specific identifying data comprises subscribed identity module (SIM) card data from a SIM card within the electronic device.

10. The system of claim 9, wherein the user comprises a service provider having a need to authenticate the electronic device.

11. The system of claim 10, wherein the agent for interrogating and the agent for providing are associated with the service provider.

12. The system of claim 8, the challenge response pair comprising a challenge portion and a response portion, and wherein the user is operable to communicate the challenge portion to the device and to receive from the device a response based upon the challenge and the device specific identifying data.

13. The system of claim 8, wherein the agent for providing the challenge response pair comprises a challenge response pair broker.

14. A method of providing an authentication service comprising the steps of:
obtaining from an electronic device a plurality of challenge response pairs the challenge response pairs having a challenge portion and a response portion, the response portion being based upon the challenge and device specific identifying data associated with the electronic device;
storing the challenge response pairs; and
providing responsive to a request for an authentication service a challenge response pair to a service provider for authenticating the electronic device.

15. The method of claim 14, wherein the step of obtaining from an electronic device a plurality of challenge response pairs comprises generating from a subscribed identify module (SIM) card a plurality of challenge response pairs and providing the SIM card to a user of the electronic device.

16. The method of claim 14, wherein the step of providing response to a request for an authentication service a challenge response pair comprises vending the challenge response pair.

17. The method of claim 14, wherein the step of providing response to a request for an authentication service a challenge response pair comprises securely communicating the challenge response pair to the service provider.
